(19) United States
(12) Patent Application Publication
(10) Pub. No.: US 2010/0217769 A1
(43) Pub. Date: Aug. 26, 2010

(54) RELATED CONTENT DISPLAY DEVICE AND SYSTEM

(75) Inventor: Yuko MATSUI, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/708,235

(22) Filed: Feb. 18, 2010

(30) Foreign Application Priority Data
Feb. 23, 2009 (JP) 2009-039179

(51) Int. Cl. G06F 17/30

(52) U.S. Cl. 707/754; 707/E17.022

(57) ABSTRACT

A keyword extraction program is automatically executed when a content being created is displayed on an LCD of a client terminal. Keywords are extracted from the content and sent with a signal requesting a retrieval of related contents to a server. In the server, contents including the same or analogous keywords to the sent keywords are extracted as related contents from a content DB and a display sequence tag is attached to a title of each related content in descending order of relevancy. According to the display sequence tag, creator's name, division and contact information are read out from a creator DB and sent to the client terminal from the server. The title of the related content, the creator's name, division and contact information received from the server are displayed in a right pane of a content creation screen displayed on the LCD.

### BACKGROUND OF THE INVENTION

1. Field of the Invention

The present invention relates to display device and display system for displaying one or more related contents of a content being displayed.

2. Description Related to the Prior Art

There is known an information acquisition system in which a staff like a salesperson who works outside a company can acquire information such as sales management information and customer information managed in the company, by accessing from an outside terminal (personal computer, etc.) to inside database through the internet and instructing, for example, “search of customer information” (JP-A 2004-38259).

There is also known a document search device and program in which, upon instructing search with “fuzzy search”, keywords are extracted from a document displayed by active application software. Based on the keywords, relevancy to a document displayed by non-active application software is examined, and a related document is displayed (JP-A 2006-146458).

There is known a content display device and method in which, a feature quantity of a main content (for example, music) to which a user pays attention is specified according to the user's search behavior, and the feature quantity is digitized to obtain a feature vector. A sub-content (for example, advertisement) whose feature vector is closest to that of the main content is selected and displayed as a related content of the main content (JP-A 2008-52665).

There is also known a reproducing apparatus in which, when caption display is instructed by a user during the reproduction of a content (TV program), captions related or tied to the content being reproduced are displayed. Upon selecting a predetermined keyword from the captions, the content being reproduced is switched to an image or program tied to the caption including this keyword (JP-A 2008-61120).

In any device, apparatus or system of the above-mentioned publications JP-A 2004-38259, JP-A 2006-146458, JP-A 2008-52665 and JP-A 2008-61120, the related contents of the content being displayed are displayed only after the user requests to search them. That is, the related contents will not be displayed until the user attempts to search them. When creating a content, if a person does not know that related contents which are similar to what he or she is going to create already exist, a similar content is created redundantly, which is waste of time and effort. On the contrary, if the person knows the existence of the related contents, he or she can save the trouble of creating the content from the beginning or even improve the quality of the new content by referring to the related contents. The quality of the content can be further improved by asking creators of the related contents for advice. In addition, while browsing the existing content, the user can obtain accurate and wide range of information by also browsing the related contents of the currently browsing content.

### SUMMARY OF THE INVENTION

In view of the foregoing problems, an object of the present invention is to provide a related content display device and system in which at least a part of a related content of the content currently being displayed and/or information of the related content, such as contact information of the creator, are automatically displayed in the display section.

In order to achieve the above and other objects, a related content display device of the present invention includes a content database, a creator database, a display section, a keyword extraction section, and a control section. In the content database, a plurality of contents and keywords are associated and registered. In the creator database, information of creators of the contents is registered. The display section displays at least one of the contents registered in the content database or a content being created. The keyword extraction section extracts one or more keywords from the content displayed in the display section. The control section retrieves at least one related content of the displayed content from the content database based on the extracted keywords. The control section also retrieves information of the creator of the related content from the creator database. The control section then displays at least a part of the related content and the creator's information in the display section.

It is preferable that the control section displays at least a part of the related content and the creator's information next to the currently displayed content in the display section.

It is preferable that a thesaurus database is further provided. In the thesaurus database, analogous keywords are registered. The control section retrieves a content having the same or analogous keywords of the extracted keywords as the related content from the content database.

It is preferable that the creator's information includes at least the creator's name, division, and contact information.

It is preferable that an indicating section is further provided. The indicating section indicates at least a part of the creator's information displayed in the display section. When a part of the creator's information is indicated by the indicating section, the control section retrieves additional information of the creator from the creator database and displays the additional information in the display section.

It is preferable that the creator's additional information includes information showing at least a part of the related content created by the creator.

A related content display system of the present invention includes a terminal, a content database, a creator database, a server, and a control section. The terminal includes a display section, a keyword extraction section, and a first communication section. The display section displays a predetermined content. The keyword extraction section extracts a keyword included in the content displayed in the display section. The first communication section communicates and sends the keyword to the outside. In the content database, content and the keyword are associated and registered. In the creator database, information of creator of the content is registered. The server includes a retrieval section and a second communication section. The retrieval section retrieves at least one related content of the displayed content from the content database based on the keyword received from the terminal as well as retrieving information of the creator of the related content from the creator database. The second communication section receives the keyword from the terminal and sends apart of the related content and the creator's information retrieved by the retrieval section to the terminal. The control section is provided in the terminal, and displays at least a part of the related content and the creator's information received from the server in the display section.

According to the present invention, when an existing content or a content being created is displayed in a display section, one or more keywords are extracted from the content. Based on these keywords, at least one related content of the displayed content is retrieved from a content database, and also information of the creator of the related content is retrieved from a creator database. Then at least a part of the related content and the creator's information are displayed in the display section. Owing to this, at least a part of the related content of the content currently being displayed and/or the information of the related content, such as contact information of the creator, are automatically displayed in the display section. Consequently, when a user creates content, the user can use the related content as a base of the new content, or ask the creator of the related content for advice, and thereby saving the trouble of creating the content from the beginning, or improving the quality of the new content. Moreover, while browsing the existing content, the user can browse the related content of the content currently browsing, and thereby obtaining more accurate and wider range of information.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a related content display system;

FIG. 2 is a functional block diagram illustrating a control apparatus of a client terminal;

FIG. 3 is a functional block diagram illustrating a server;

FIG. 4 is a data table in a content DB representing correspondence relation between content and keyword;

FIG. 5 is a data table in a creator DB representing correspondence relation among creator, division, contact information, and title of the content;

FIG. 6 is a display screen displaying content creation screen and right pane;

FIG. 7 is the display screen displaying creator's work information; and

FIG. 8 is a flowchart illustrating procedures of processing performed by the client terminal and the server.

### DESCRIPTION OF THE PREFERRED EMBODIMENTS

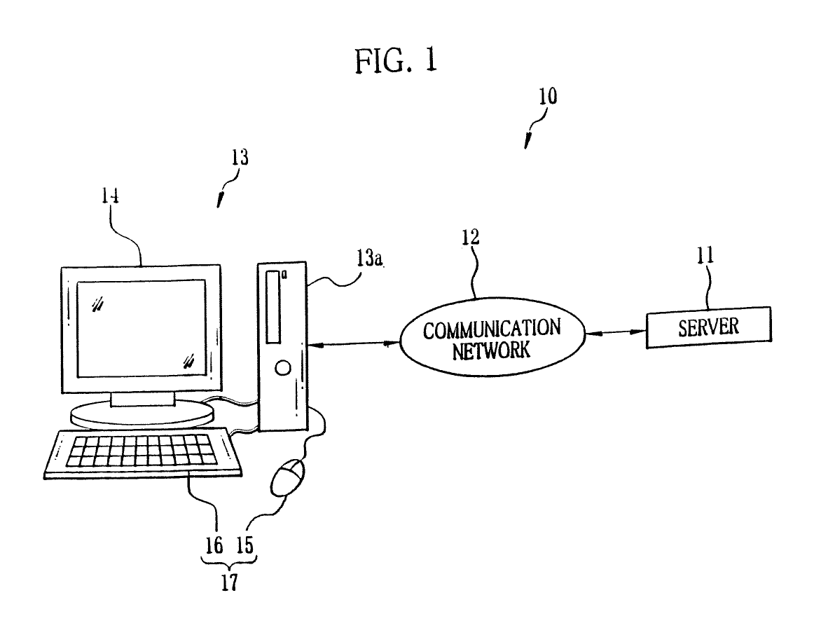

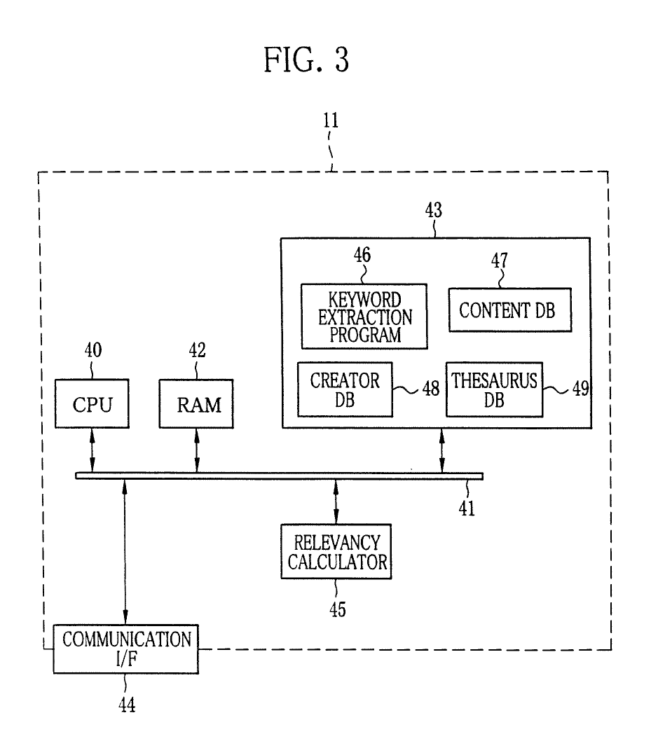

As shown in FIG. 1, a related content display system 10 is constituted of a server 11 having a content database (DB) 47 (see FIG. 3), and a client terminal 13 connected to the server 11 through a communication network 12. The related content display system 10 is used in a specific community or group like a company (hereinafter, referred to as community). Hereinafter, a case where document data like technical data, research data, and the like is used as a content is explained.

The client terminal 13 is, for example, a well known personal computer or work station, and has a control apparatus 13a, a liquid crystal display (LCD) 14 and an operating section 17, which is constituted of a mouse 15 and a keyboard 16. The operating section 17 outputs operation signals. Besides the LCD, CRT and the like may also be used as the display device.

The related content display system 10 retrieves one or more related contents which are highly relevant to the content displayed on the LCD 14 and the information of their creators from the server 11, and displays the related contents and the creators' information on the LCD 14 so that, if necessary, a user can contact the creators. The content displayed on the LCD 14 is not limited to the existing content, but may be a content which is being created by the user with the client terminal 13.

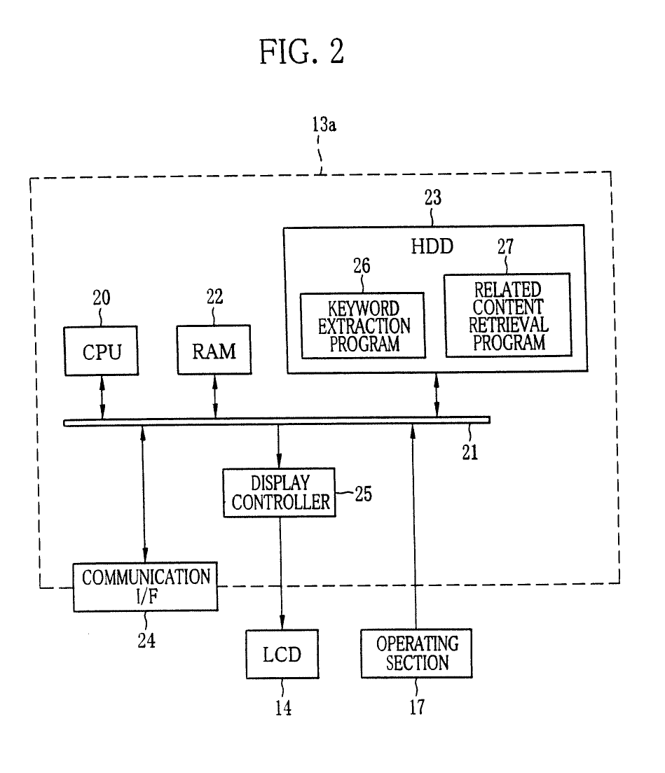

In FIG. 2, A CPU 20 controls respective components of the control apparatus 13a according to the operation signals input through the operating section 17. In addition to the operating section 17, a RAM 22, a HDD 23, a communication interface (I/F) 24 and a display controller 25 are connected by a data bus 21 to the CPU 20.

The communication I/F 24 is, for example, a modem or a router, which controls communication protocol suitable for the communication network 12 and interfaces the data communication through the communication network 12. The display controller 25 controls the LCD 14 to display contents and the like (see FIG. 3).

The RAM 22 is a work memory used for the CPU 20 to execute various processing. The HDD 23 stores various programs and data for operating the client terminal 13. The CPU 20 reads the program out of the HDD 23 and develops it on the RAM 22 to process it sequentially.

The HDD 23 stores a keyword extraction program 26 and a related content retrieval program 27. When the keyword extraction program 26 is executed, keywords are automatically extracted from the content displayed on the LCD 14 . As the keyword, a title of the content, words frequently, for example at least 3 times, appearing in the content, and the like may be selected. If the content is being created, the word input last (most newly input word) is selected as the keyword in addition to the title of the content and the frequently-appearing words.

The related content retrieval program 27 sends the keywords extracted by the keyword extraction program 26 along with a signal requesting a retrieval of related contents to the server 11 through the communication I/F 24 and the communication network 12. Normally, all the contents stored in the server 11 are targeted for the retrieval. However, under the instruction by the user through the keyboard 16 of the client terminal 13, only the contents belonging to a specific division or the contents allowed to be accessed will be targeted for the retrieval.

In FIG. 3, a CPU 40 controls respective components of the server 11 according to the operation signals and the request signal for retrieving related contents input by the client terminal 13 through the communication network 12.

A RAM 42, a HDD 43, a communication interface (I/F) 44 and a relevancy calculator 45 are connected by a data bus 41 to the CPU 40.

The RAM 42 is a work memory used for the CPU 40 to execute various processing. The HDD 43 stores various programs and data for operating the sever 11. The CPU 40 reads the program out of the HDD 43 and develops it on the RAM 42 to process it sequentially.

The communication I/F 44 controls communication protocol suitable for the communication network 12 and interfaces the data communication through the communication network 12. Data obtained through the communication I/F 44 is temporarily stored in the RAM 42.

The HDD 43 stores a keyword extraction program 46, a content database (DB) 47, a creator database (DB) 48 and a thesaurus database (DB) 49. The thesaurus DB 49 stores data of thesaurus in which words are classified and systematized according to relationship, such as super-sub relation, part-hole relation, synonymous/analogous relation, and the like between the words.

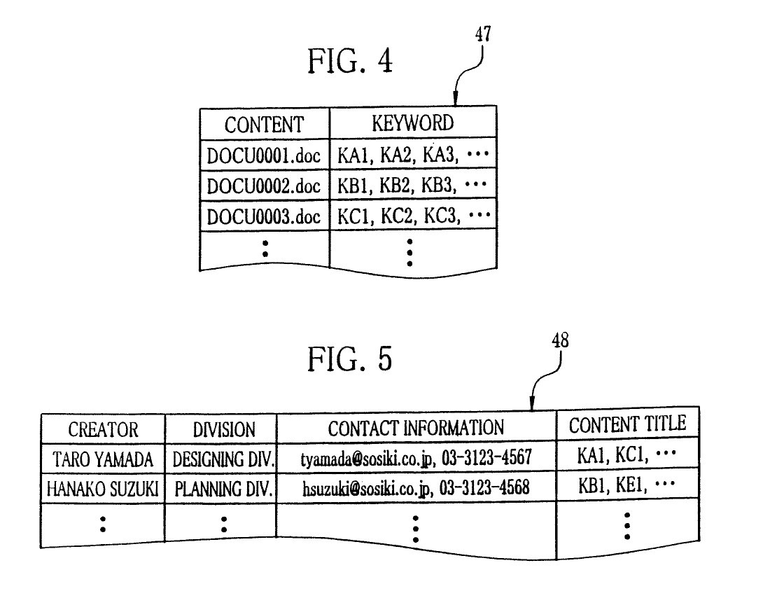

When a content is registered using the client terminal 13, the keyword extraction program 46 extracts keywords from the content sent from the client terminal 13 through the communication I/F 44 and temporarily stores the keywords in the RAM 42. As shown in FIG. 4, the CPU 40 associates the content with the keywords temporarily stored in the RAM 42 and register them in the content DB 47. In addition to the content sent from the client terminal 13, a content input from a recording medium like a CD-ROM can also be registered in the content DB 47. These contents gathered throughout the community and the keywords extracted from the contents are associated with each other and stored in the content DB 47.

As the content, document data “DOCU0001.doc”, “DOCU0002.doc”, “DOCU0003.doc”, . . . are registered. For the document data “DOCU00001.doc”, for example, keywords “KA1”, “KA2”, “KA3”, . . . are registered. “KA1” is a title of the document data “DOCU0001.doc”. “KA2” and “KA3” are data of words appearing, for example, at least 3 times in the document data “DOCU0001.doc”.

As shown in FIG. 5, the creator DB 48 stores names of creators who are the staffs of the community and created at least one content (for example, TARO YAMADA), their divisions (for example, DESIGNING DIV.), their contact information (e-mail address and phone number), and titles of the content created by the respective creators (“KA1”, “KC1”, . . . ) as being associated with each other in a data table.

When the CPU 40 receives the keywords of the content displayed on the LCD 14 and the request signal for retrieving related contents of the displayed content from the client terminal 13, the CPU 40 searches the thesaurus DB 49 and reads out keywords similar to the received keywords (hereinafter, analogous keywords). The CPU 40 then searches the content DB 47 and reads out the contents having the same or analogous keywords to the keywords sent from the client terminal 13 and temporarily stores them as related contents in the RAM 42. The so-called “fuzzy search” is performed with the analogous keywords.

The relevancy calculator 45 refers to the related contents stored in the RAM 42 and ranks them in the order of relevance to the content displayed on the LCD 14 of the client terminal 13 according to the number of the keywords and the analogous keywords that each related content has. The relevancy calculator 45 then attaches a tag indicating the order in which the content to be displayed (display sequence tag) as a title of the related content so that the higher the relevancy of the related content, the higher the related content is displayed in a right pane 52 of the display screen.

According to the display sequence tag attached to the title of the related content, the CPU 40 reads out name, division and contact information of the creator of the related content from the creator DB 48, and sends them along with the title having the display sequence tag to the client terminal 13 through the communication I/F 44 and the communication network 12.

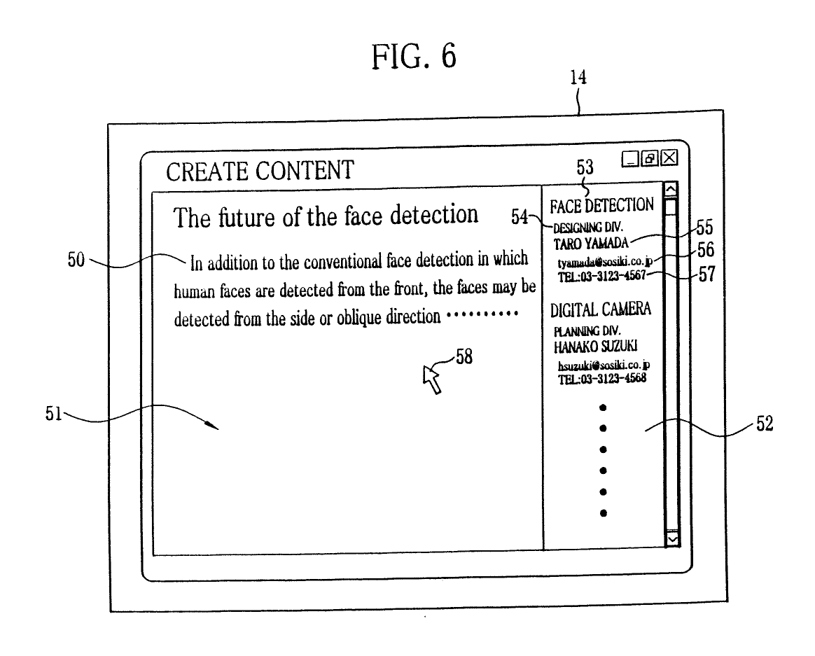

The client terminal 13 stores the creator's name, division and contact information received from the server 11 through the communication network 12 and the communication I/F 24 in the RAM 22. At the same time, the client terminal 13 activates the display controller 25 to display the creator's name, division and contact information in the right pane 52 of a content creation screen 51 on the LCD 14 which also displays content 50 being created, as shown in FIG. 6. In the drawing, a numeral 53 indicates the title of the related content, a numeral 54 indicates the creator's division, a numeral 55 indicates the creator's name, and numerals 56 and 57 respectively indicate e-mail address and phone number which are the creator's contact information.

When the mouse 15 is clicked with a cursor 58 on the title 53, the CPU 20 of the client terminal 13 sends a request for access permission to the server 11. ID like serial number of the client terminal to which the access permission is granted is preliminarily registered on each of the contents stored in the content DB 47. When the CPU 40 of the server 11 receives the request for access permission from the client terminal whose ID is not registered on the requested related content, the CPU 40 sends a message to the client terminal to inform that the client terminal does not have the access permission, and denies the access. It is possible to display a mark or a color for differentiation near the title 53 so that the presence of access permission can be known on the screen.

If the user still wants to access the related content even after the message informing that the client terminal does not have the access permission is displayed on the LCD 14, the user of the client terminal 13 sends an application to an administrator (normally an administrator of the server 11 or the creator of the related content) for issuance of access permission to this related content. The application may be made by, for example, an e-mail with a format in accordance with a document management system in the community. In this case, for example, a button indicating “application for access permission” is displayed in the content creation screen 51. When the button is clicked, e-mail software preliminarily stored in the client terminal 13 is activated, and a name of the applicant (name of the user of the client terminal 13) and a title of the content which the user wants to access (for example, the title 53) are automatically input in the appropriate box of the application form. Once the user receives a reply mail granting the access permission from the administrator, the user can access the related content which he or she wants to access.

When the CPU 40 of the server 11 receives the request for access permission from the client terminal 13 whose ID is registered on the requested related content, the corresponding related content is downloaded from the server 11 to the client terminal 13 and displayed on the LCD 14.

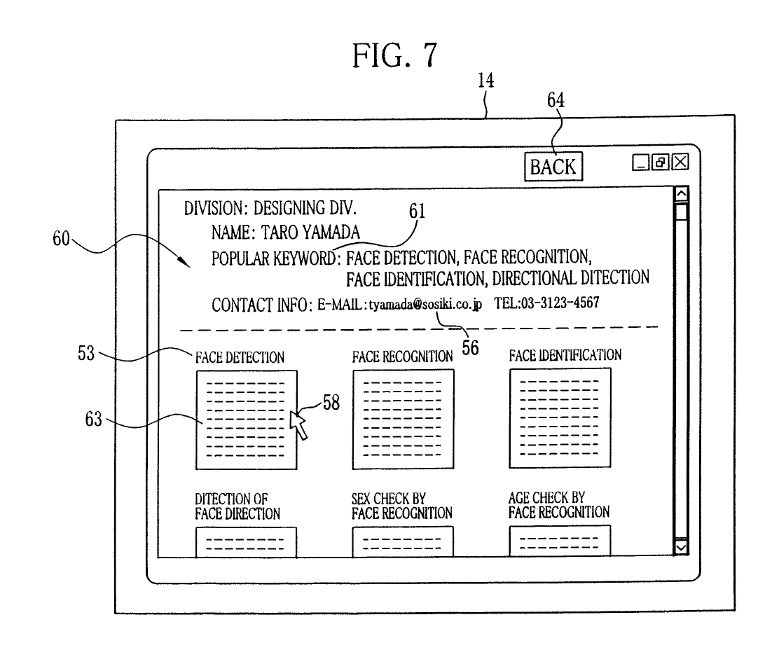

When the mouse 15 is clicked with the cursor 58 on the creator's name 55, detailed work information 60 of this creator is downloaded from the server 11 and displayed as a list on the LCD 14, as shown in FIG. 7. The work information 60 includes popular or representative keywords 61 of the contents created by this creator, title 53 and thumbnail image (reduced images) 63 of a representative page of each content, and the like. Note that a back button 64 is provided at the top of the screen of the LCD 14, and the screen goes back to the content creation screen shown in FIG. 6 when the mouse 15 is clicked with the cursor 58 on the back button 64.

When the mouse 15 is clicked with the cursor 58 on the thumbnail image 63, the client terminal 13 sends a request for access permission of content corresponding to the thumbnail image 63 to the server 11. The CPU 40 of the server 11 checks whether the client terminal 13 is granted the access permission on the content. If the client terminal is not granted the access permission, the CPU 40 sends the message of denying the access to the client terminal. If the client terminal 13 is granted the access permission, the CPU 40 sends whole data of the content (related content) corresponding to the thumbnail image 63 to the client terminal 13.

After receiving the whole data of the related content, the client terminal 13 displays it on the LCD 14. If the whole related content cannot be displayed on one screen of the LCD 14, it is browsed by scrolling.

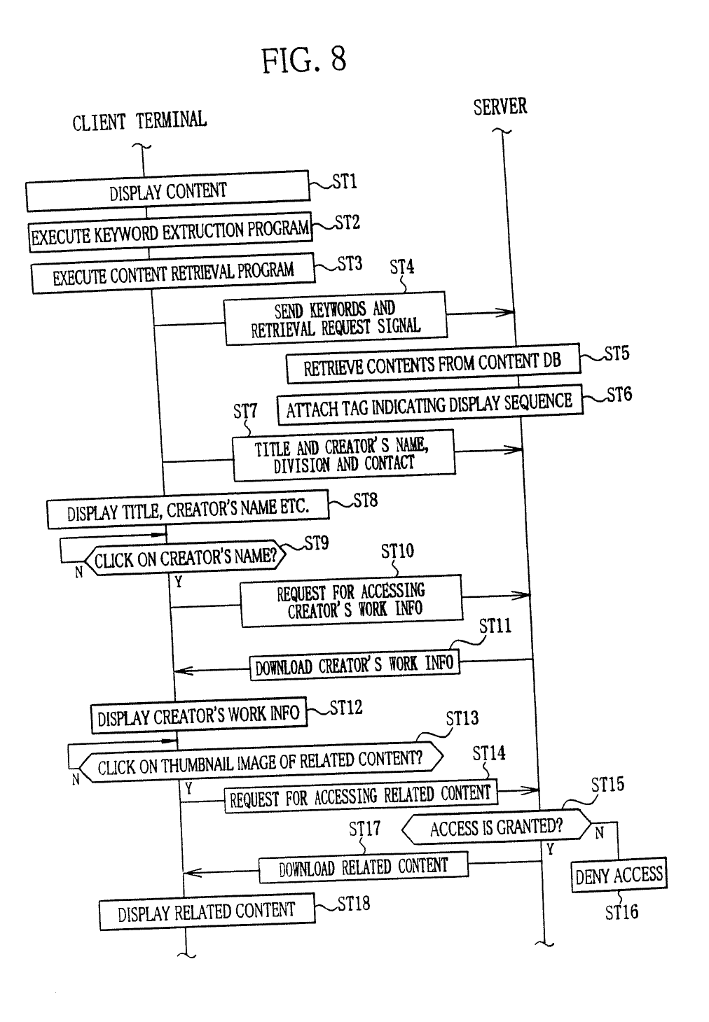

Hereinafter, an operation of the related content display system 10 having the above-described configuration will be explained with reference to the flowchart of FIG. 8. Note that the letters ST1 to ST18 in parentheses correspond to the same in FIG. 8. When the content 50 being created is displayed in the content creation screen 51 on the LCD 14 of the client terminal 13 (ST1), the keyword extraction program 26 is automatically executed (ST2).

Owing to this, the frequently-appearing words like, for example, “face detection”, “front” and “side”, which appear at least 3 times in the content 50, and the word input last are extracted, in addition to the title “The future of the face detection”, as the keywords.

The related content retrieval program 27 is then executed (ST3), and the keywords and the signal requesting a retrieval of the related contents are sent together to the server 11 through the communication I/F 24 and the communication network 12 (ST4).

Once the keywords and the request signal for retrieving the related contents are received in the server 11 from the client terminal 13, the analogous keywords are read out from the thesaurus DB 49, and the contents having the same keywords as sent from the client terminal 13 or the analogous keywords are searched and extracted as the related contents (ST5).

Next, the relevancy calculator 45 is activated for the related contents extracted from the content DB 47, and the display sequence tag is attached to the title of each related content such that the related content having more keywords and analogous keywords is displayed upper than the other related contents in the right pane 52 (ST6).

The name, division and contact information of the creator of the related content are read out from the creator DB 48 according to the display sequence tag attached to the title of the related content, and sent along with the title having the display sequence tag from the server 11 to the client terminal 13 through the communication I/F 44 and the communication network 12 (ST7).

The creator's name, division and contact information received from the server 11 are displayed in the right pane 52 of the content creation screen 51 on the LCD 14 of the client terminal 13 (ST8).

When the creator's name 55 is clicked (ST9), the request for access permission of the detailed work information 60 of this creator is sent from the client terminal 13 to the server 11 (ST10). Then the work information 60 is downloaded from the server 11 (ST11) and displayed as a list on the LCD 14 (ST12).

Once the thumbnail image 63 showing a representative page of the related content is clicked (ST13), the request for access permission of the corresponding related content is sent from the client terminal 13 to the server 11 (ST14). The CPU 40 of the server 11 checks whether the client terminal 13 is granted the access permission on this related content (ST15). If the client terminal is not granted the access permission, the access is denied (ST16).

If the client terminal 13 is granted the access permission (ST15), data of the related content corresponding to the clicked thumbnail image 63 is downloaded from the server 11 to the client terminal 13 (ST17), and the related content is displayed on the LCD 14 (ST18).

When the e-mail address 56 is clicked while the content creation screen 51, as shown in FIG. 6, or the work information 60, as shown in FIG. 7, is displayed on the LCD 14, the e-mail software preliminarily stored in the client terminal 13 is activated which allows the user to send an e-mail asking questions and the like.

In the above-described operation, the related content is displayed by clicking the title 53 of the related content in the content creation screen 51 in the same manner as the steps ST13 to ST18, and therefore the detailed explanation thereof is omitted.

In the above embodiment, the related content display system is explained. However, it is also possible that the client terminal 13 is used as a related content display device by providing the client terminal 13 with the functions of the server 11. Specifically, the client terminal 13 will be provided with the relevancy calculator 45, and the HDD 23 will be provided with the content DB 47, the creator DB 48 and the thesaurus DB 49.

In the above embodiment, the case where the content being created is displayed on the LCD is explained. In the case where the existing content is displayed, the operation is the same except that the word input last is not selected as the keyword, and therefore the detailed explanation thereof is omitted.

In the above embodiment, although the access permission is not required to display the creator's work information, the access permission can be required.

In the above embodiment, the case where the content is document data is explained. In addition to the document data, the content may also be image data, movie data, music data, computer software or web page, or a combination of these items. In this case, the keyword extracted from the content may mainly be a title of the content. The keyword extracted from the content is not limited to letters, but may be symbols or numbers.

In the above embodiment, the title of the content, the creator's name and contact information are displayed in the right pane of the screen. In addition to this, excerpt from the content or first several lines of the content may also be displayed. The display section is not limited to the LCD, but may be a CRT, an organic EL display, or the like.

In the above embodiment, e-mail with the format in accordance with the document management system in the community is used to apply for the access permission when the user wants to access the content to which the access permission is not granted. The application for the access permission can be in any form depending on the user.

Various changes and modifications are possible in the present invention and may be understood to be within the present invention.

What is claimed is:

1. A related content display device comprising:
a content database in which a plurality of contents and keywords are associated and registered;
a creator database in which information of creators of said contents is registered;
a display section for displaying at least one said content registered in said content database or a content being created;
a keyword extraction section for extracting one or more keywords from said content displayed in said display section; and
a control section for retrieving at least one related content of said displayed content from said content database based on said extracted keywords as well as retrieving information of the creator of said related content from said creator database, and for displaying at least a part of said related content and said creator's information in said display section.

2. The related content display device described in claim 1, wherein said control section displays at least a part of said related content and said creator's information next to the currently displayed content in said display section.

3. The related content display device described in claim 2 further comprising:
a thesaurus database in which analogous keywords are registered, wherein said control section retrieves a content having the same or analogous keywords of said extracted keywords as said related content from said content database.

4. The related content display device described in claim 3, wherein said creator's information includes at least said creator's name, division, and contact information.

5. The related content display device described in claim 4 further comprising:
an indicating section for indicating at least a part of said creator's information displayed in said display section, wherein when a part of said creator's information is indicated by said indicating section, said control section retrieves additional information of said creator from said creator database and displays said additional information in said display section.

6. The related content display device described in claim 5, wherein said additional information includes information showing at least a part of said related content created by said creator.

7. A related content display system comprising:
a terminal including a display section for displaying a predetermined content, a keyword extraction section for extracting a keyword included in said content displayed in said display section, and a first communication section which communicates and sends said keyword to the outside;
a content database in which content and said keyword are associated and registered;
a creator database in which information of creator of said content is registered;
a server including a retrieval section for retrieving at least one related content of said displayed content from said content database based on said keyword received from said terminal as well as retrieving information of the creator of said related content from said creator database, and a second communication section for receiving said keyword from said terminal and sending a part of said related content and said creator's information retrieved by said retrieval section to said terminal; and
a control section provided in said terminal and for displaying at least a part of said related content and said creator's information received from said server in said display section.
